(19) United States
(12) Patent Application Publication
(10) Pub. No.: US 2015/0263814 A1
(43) Pub. Date: Sep. 17, 2015

(54) MULTIMEDIA SYSTEM FOR TRANSPORTATION DEVICE USING SINGLE COMMUNICATION LINE

(71) Applicant: KWANG SUNG ELECTRONICS KOREA CO., LTD., Gunpo-si, Gyeonggi-do (KR)

(72) Inventor: Kyu Young Lee, Seoul (KR)

(21) Appl. No.: 14/425,066

(22) PCT Filed: Aug. 16, 2013
(86) PCT No.: PCT/KR2013/007400

§ 371 Date: Mar. 2, 2015

(30) Foreign Application Priority Data
Aug. 29, 2012 (KR) 20-2012-0094664

(51) Int. Cl. H04B 15/00; H04B 1/3822; H04L 29/08; H04B 3/02

(52) U.S. Cl. CPC H04B 15/00; H04B 3/02; H04B 1/3822; H04L 67/12

(57) ABSTRACT

A multimedia system for a transportation device using a single communication line includes: an antenna transmitting and receiving a signal; an integrated tuner device processing the signal delivered from the antenna; a head unit realizing a multimedia service through the signal transmitted from the integrated tuner device, wherein the integrated tuner device is formed independently from the head unit, and the integrated tuner device is installed in the proximity of the antenna.

### TECHNICAL FIELD

The present invention relates to a multimedia system for a transportation apparatus using a single communication line and, more particularly, to a multimedia system for a transportation apparatus in which tuner devices are installed in a structure independent from a head unit, the independent tuner devices are integrally installed close to antenna, and the integrated tuner devices and the head unit are coupled through a single communication line.

### BACKGROUND ART

A multimedia system for a transportation apparatus is a system installed to provide a multimedia service within a transportation apparatus, such as a vehicle, and a system for providing services, such as a car audio service, video service, an analog broadcasting service, a digital broadcasting service, a telematics service, a communication service, and other services, within a transportation apparatus. Such a multimedia system for a transportation apparatus may be implemented in various forms, such as a car audio system.

A conventional multimedia system for a transportation apparatus is described below with reference to FIGS. 1 and 2.

Referring to FIGS. 1 and 2, the conventional multimedia system for a transportation apparatus has been configured in which tuner devices are installed within a head unit, has been configured in which antennas and the tuner devices within the head unit are coupled by remote coaxial lines, and has been configured in which a plurality of coaxial lines is coupled between both devices (the antennas/the tuner devices the head unit).

Accordingly, the conventional multimedia system for a transportation apparatus was problematic in that reception sensitivity may be deteriorated because noise (electric field noise) generated from the engine or driving motors (a cell motor, a wiper motor, etc.) of a transportation apparatus (e.g., a vehicle) easily affects the signal bands of the tuner devices installed within the head unit due to the nature of the head unit disposed close to the engine room of the transportation apparatus.

Furthermore, there were problems in that a loss of the coaxial line itself is increased because the length (about 5 meters) of the coaxial line is increased and reception sensitivity of a signal may be deteriorated because a mismatch loss is generated between the antennas and the tuner devices of the head unit.

Furthermore, there were problems in that the complexity of a system is increased, the noise of each coaxial line and a mismatch between signals must be independently managed, and it is difficult to integrally control the tuner devices because the plurality of coaxial lines (for various signals of the plurality of tuner devices) and a power line (in the case of an active type antenna) are required between both the elements (the antennas/the head unit+the tuner devices) disposed at remote places.

Accordingly, there is a need to develop a new concept of a multimedia system for a transportation apparatus which can solve the conventional problems.

The present invention has been invented to satisfy the aforementioned technical need and has been invented to solve such problems and to provide a technology that cannot be easily developed by those skilled in the art to which the present invention pertains.

### PRIOR ART DOCUMENT

[Patent Document] (Patent Document 1) KR2006-0016335 A

### DISCLOSURE

### Technical Problem

An object of a multimedia system for a transportation apparatus in accordance with an embodiment of the present invention is to implement a multimedia system for a transportation apparatus in which tuner devices are installed in a structure independent from a head unit, the independent tuner devices are integrally installed close to an antenna, and an integrated tuner device and the head unit are coupled through a single communication line.

### Technical Solution

To achieve the above object, the multimedia system for a transportation apparatus in accordance with an embodiment of the present invention includes an antenna for transmitting and receiving signals; an integrated tuner device for processing the signals transmitted by the antenna; and a head unit for implementing a multimedia service through the signals transmitted by the integrated tuner device, wherein the integrated tuner device is configured in a form independent from the head unit, and the integrated tuner device is installed near the antenna.

Furthermore, in the multimedia system for a transportation apparatus in accordance with an embodiment of the present invention, the integrated tuner device integrally receives and processes a plurality of multimedia signals, and the plurality of multimedia signals includes a broadcasting signal, a communication signal, or a telematics service signal.

Furthermore, in the multimedia system for a transportation apparatus in accordance with an embodiment of the present invention, the integrated tuner device and the head unit mutually transmit and receive signals according to a single data format through a single communication line.

Furthermore, in the multimedia system for a transportation apparatus in accordance with an embodiment of the present invention, the integrated tuner device transmits signals of a single data format to the head unit.

Furthermore, in the multimedia system for a transportation apparatus in accordance with an embodiment of the present invention, the integrated tuner device includes a self-control unit capable of controlling an operation for processing the plurality of multimedia signals and of controlling an initialization operation of the integrated tuner device.

Furthermore, in the multimedia system for a transportation apparatus in accordance with an embodiment of the present invention, the integrated tuner device includes an integrated signal transmission/reception unit which is connected to the antenna and transmits and receives the plurality of multimedia signals; an integrated signal processing unit which processes the signals received by the integrated signal transmission/reception unit and extracts multimedia information; a communication unit for transmitting and receiving signals to and from the head unit; and a control unit for controlling operations of the integrated signal transmission/reception unit, the integrated signal processing unit, and the communication unit.

Furthermore, in the multimedia system for a transportation apparatus in accordance with an embodiment of the present invention, the control unit converts extracted multimedia information into signals of a single format that is capable of including a header region, a command region, an information region, and an error verification region by not taking into consideration a type of the extracted multimedia information, and the communication unit transmits and receives signals to and from the head unit through a single communication line.

Furthermore, in the multimedia system for a transportation apparatus in accordance with an embodiment of the present invention, the signal of a single format may include a header region, a command region, an information region, and an error verification region.

Furthermore, in the multimedia system for a transportation apparatus in accordance with an embodiment of the present invention, the information region includes encrypted multimedia service information.

Furthermore, in the multimedia system for a transportation apparatus in accordance with an embodiment of the present invention, the control unit is capable of controlling the operations of the integrated signal transmission/reception unit, the integrated signal processing unit, and the communication unit based on a signal transmitted by the head unit.

Furthermore, in the multimedia system for a transportation apparatus in accordance with an embodiment of the present invention, the control unit mainly controls the entire multimedia system for a transportation apparatus.

Furthermore, in the multimedia system for a transportation apparatus in accordance with an embodiment of the present invention, the control unit may perform an operation for initializing the integrated tuner device or the head unit and perform main control based on information received from the head unit so that a specific multimedia service can be provided.

Furthermore, in the multimedia system for a transportation apparatus in accordance with an embodiment of the present invention, the head unit includes an input unit for receiving information from a user; a display unit for displaying a multimedia service; a communication unit for transmitting and receiving signals to and from the integrated tuner device; and a control unit for controlling the operations of the input unit, the display unit, and the communication unit.

Furthermore, in the multimedia system for transportation apparatus in accordance with an embodiment of the present invention, the communication unit transmits and receives signals to and from the integrated tuner device through a single communication line and transmits and receives encrypted signals.

### Advantageous Effects

In the multimedia system for a transportation apparatus in accordance with an embodiment of the present invention, the plurality of tuner devices for a multimedia service can be configured in the form of an integrated tuner device, and the integrated tuner device can be configured in a form independent from the head unit. Accordingly, the integrated tuner device can deviate from the influence of noise (electric field noise) generated from an engine or driving motor near the head unit, the integrated tuner device may not be subject to interference from a variety of types of synchronization clock signals within the head unit, and reception sensitivity of the integrated tuner device can be significantly improved.

Furthermore, the multimedia system for a transportation apparatus in accordance with an embodiment of the present invention can be configured in such a manner that the independent integrated tuner device is installed close to the antenna. Accordingly, a mismatch loss that may occur between the antenna and the tuner device can be reduced, and reception sensitivity can be significantly improved.

Furthermore, in the multimedia system for a transportation apparatus in accordance with an embodiment of the present invention, the integrated tuner device and the head unit configured in an independent form are coupled through a single communication line and can exchange signals according to a single data format. Accordingly, a line loss, a mismatch between signals, and reception sensitivity do not need to be separately managed with respect to each of a plurality of tuner devices (a plurality of coaxial lines), and a plurality of multimedia signals can be integrally managed. Furthermore, complexity in the wiring task of a transportation apparatus can be significantly reduced, productivity can be improved, and fuel efficiency of a transportation apparatus can be improved due to a reduction in the number of lines.

Furthermore, in the multimedia system for a transportation apparatus in accordance with an embodiment of the present invention, the integrated tuner module may include the independent control unit, and a plurality of multimedia service functions can be autonomously controlled through the control unit. Accordingly, a load of the head unit can be reduced because the amount of information processed by the head unit is reduced. Furthermore, a plurality of multimedia service signals to be transmitted to the head unit can be converted into an output signal of a single format through a previous control operation of the independent control unit, and the converted signals can be transmitted through a single communication line.

Furthermore, in the multimedia system for a transportation apparatus in accordance with an embodiment of the present invention, the main control unit may be placed within the integrated tuner device. Accordingly, integrated control can be performed based on the operation of the integrated tuner device.

### DESCRIPTION OF DRAWINGS

FIGS. 1 and 2 are diagrams illustrating a conventional multimedia system for a transportation apparatus.

FIG. 3 is a diagram illustrating the configuration of a multimedia system for a transportation apparatus in accordance with an embodiment of the present invention.

FIG. 4 is a diagram illustrating an embodiment of an integrated tuner device which may be included in the present invention.

FIG. 5 is a diagram illustrating an embodiment of a head unit which may be included in the present invention.

FIG. 6 is a more embodied diagram illustrating the configuration of the multimedia system for a transportation apparatus in accordance with an embodiment of the present invention.

FIG. 7 is a diagram illustrating the data frame of a signal which may be transmitted and received between the integrated tuner device and the head unit in accordance with an embodiment of the present invention.

FIG. 8 is a flowchart illustrating an operation for initializing and driving, by the integrated tuner device in accordance with an embodiment of the present invention, the system.

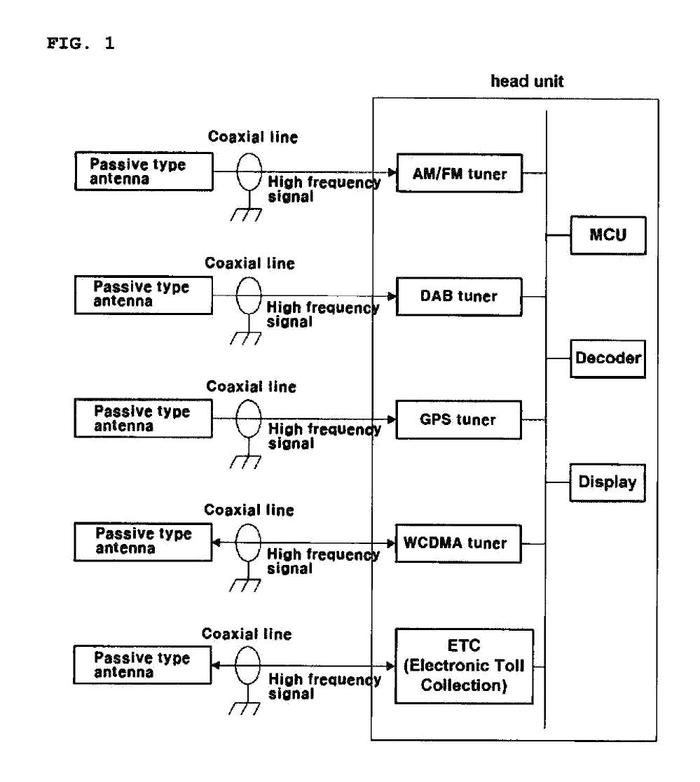

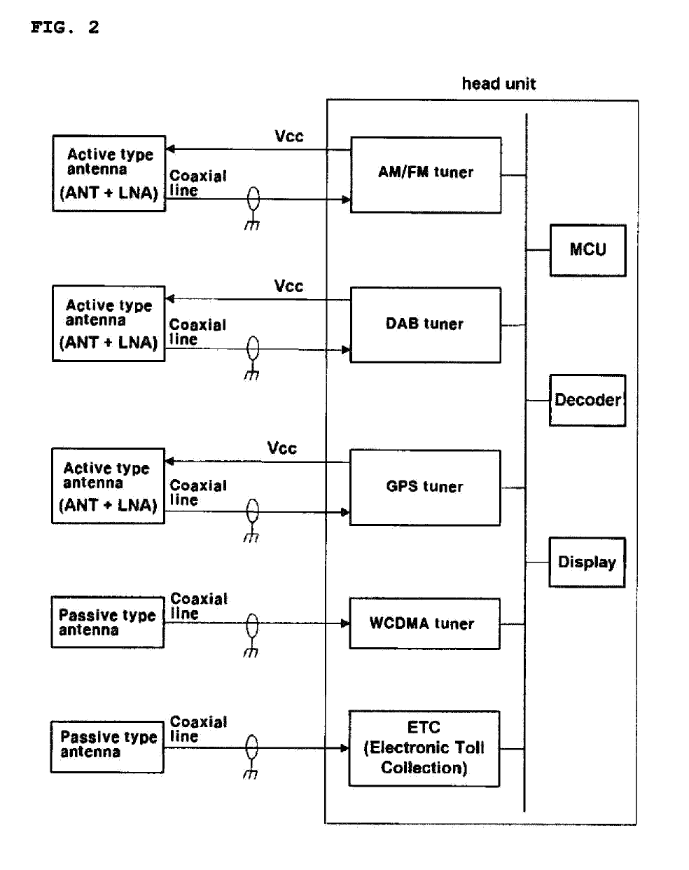

[Description of reference numerals]

| 100: integrated tuner device | |
|---|---|
| 110: integrated signal transmission/reception unit | |
| 130: integrated signal processing unit | |
| 150: communication unit | 170: control unit |
| 200: head unit | 210: input unit |
| 230: display unit | 250: communication unit |
| 270: control unit | 300: antenna |

### BEST MODE

Hereinafter, a multimedia system for a transportation apparatus in accordance with the present invention is described in detail with reference to the accompanying drawings. Embodiments to be described are provided in order for those skilled in the art to easily understand the technical spirit of the present invention, and the present invention is not restricted by the embodiments. Furthermore, matters represented in the accompanying drawings have been diagrammed in order to easily describe the embodiments of the present invention and may be different from forms that are actually implemented.

Meanwhile, it should be understood that an expression that some elements are “included” is an expression of an “open type” and the expression simply denotes that the corresponding elements are present, but does not exclude additional elements.

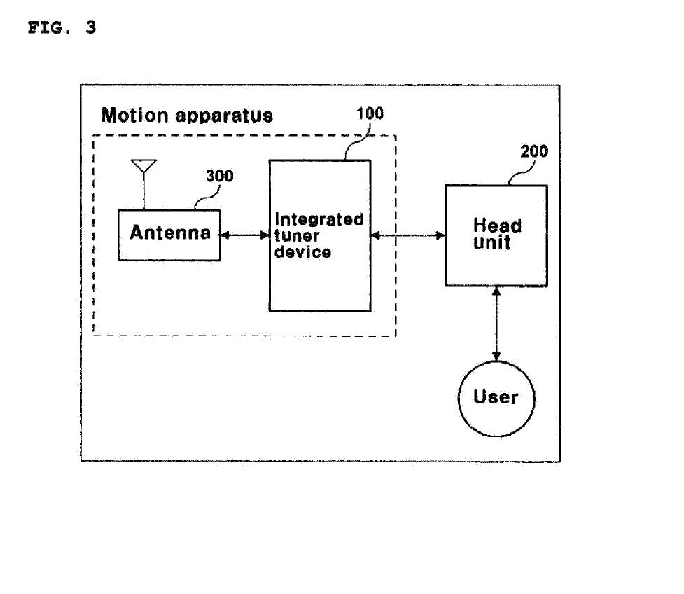

The multimedia system for a transportation apparatus in accordance with an embodiment of the present invention is described below with reference to FIG. 3.

Referring to FIG. 3, the multimedia system for a transportation apparatus in accordance with an embodiment of the present invention may include an antenna 300 for transmitting and receiving signals, an integrated tuner device 100 for processing signals transferred by the antenna, and a head unit 200 which is installed within a transportation apparatus for a multimedia service and implements a multimedia service through signals transmitted by the integrated tuner device.

In this case, the integrated tuner device 100 may be configured in a form independent from the head unit 200, and the independent integrated tuner device is preferably installed close to the antenna.

The antenna 300 is configured to receive a signal for implementing a multimedia service from the outside or to transmit a signal to the outside. The antenna 300 may receive a broadcasting signal, a communication signal, a telematics signal, etc. from the outside of the transportation apparatus and functions to transfer a received signal to the integrated tuner device 100.

Furthermore, the antenna 300 is preferably implemented transmit and receive signals having a plurality of frequency bands. More specifically, the antenna 300 may be configured in the form of an integrated antenna including plurality of radiating elements capable of transmitting and receiving signals having a plurality of frequency bands. Accordingly, signals (e.g. analog/digital broadcasting signals, a communication signal, a telemetics signal, and other signals) having a plurality of frequency bands can be transmitted and received through the plurality of radiating elements.

Furthermore, the plurality of radiating elements included in the antenna 300 may be connected to the integrated tuner device 100 through respective lines. In this case, the length of the line for connection can become short because the integrated tuner device 100 and the antenna 300 are closely disposed. Accordingly, problems, such as a line loss, a mismatch between signals, and a reduction of reception sensitivity, can be significantly reduced.

Meanwhile, the antenna 300 may be configured in such a way as to be integrated with the integrated tuner device 100. Accordingly, a mismatch between signals can be more efficiently prevented, and reception sensitivity of a signal can be further improved.

The integrated tuner device 100 is an element for extracting information by processing a signal transferred by the antenna 300 and transmitting the extracted information to another device. More specifically, the integrated tuner device 100 means an element capable of integrally receiving and processing a plurality of multimedia signals from the antenna 300, extracting multimedia information through signal processing, and transferring the extracted information to the head unit 200.

The integrated tuner device 100 is preferably configured in a form independent from the head unit 200. More preferably, the integrated tuner device 100 may be configured in such a way as to be independent from the head unit 200 and installed close to the antenna 300. Due to the nature of such a structural characteristic, the integrated tuner device 100 can deviate from the influence of noise (electric field noise) generated from an engine or driving motor near the head unit 200. The integrated tuner device 100 may not be subject to interference from a variety of types of synchronization clock signals within the head unit. Furthermore, reception sensitivity can be significantly improved because a mismatch between signals transferred by the antenna 300 is reduced.

Furthermore, the integrated tuner device 100 may include a plurality of tuner modules capable of processing a plurality of multimedia signals. For example, the integrated tuner device 100 may include a plurality of tuner modules, such as a tuner module for the reception of analog broadcasting, a tuner module for the reception of digital broadcasting, a tuner module for providing a telematics service, a tuner module for providing a communication service, and a tuner module for providing other services. The plurality of tuner modules is integrally configured to form the integrated tuner device 100.

Furthermore, the integrated tuner device 100 may receive user manipulation information from the head unit 200 and perform signal processing with reference to received information. More specifically, the integrated tuner device 100 may identify a multimedia service requested by a user and selectively process a corresponding service signal based on information received from the head unit 200, may extract information through signal processing, and may transmit the extracted information to the head unit 200.

Meanwhile, the integrated tuner device 100 may transmit and receive information through a single communication line when transmitting information to the head unit 200 after processing plurality of multimedia signals or when receiving information from the head unit 200. More specifically, the integrated tuner device 100 may integrally manage data for various services extracted by the tuner module for the reception of analog broadcasting, the tuner module for the reception of digital broadcasting, the tuner module for providing a telematics service, the tuner module for providing a communication service, and the tuner module for providing other services and transmit the data to the head unit 200 through the single communication line (physical path). Furthermore, the integrated tuner device 100 may receive all the pieces of information data transmitted by the head unit 200 through the single communication line. In this case, the single communication line means a single physical path (for reference, the physical path is one, but a plurality of logical paths may be configured through a change of transmitted and received signals) for exchanging signals and may be implemented using various transmission methods capable of transmitting and receiving signals. For example, the single communication line may be implemented using various forms of physical paths, such as Ethernet, a USB, Wi-Fi, a wired line, and other digital communication lines.

Furthermore, when transmitting and receiving signals through the single communication line, the integrated tuner device 100 may transmit and receive signals of a single format. More specifically, the integrated tuner device 100 may convert various types of information for various multimedia services into signals of a single format and transmit and receive converted signals through the single communication line. Furthermore, the integrated tuner device 100 may receive signals of the same data format transmitted by the head unit 200, may process received signals, and may extract information through signal processing.

Furthermore, the integrated tuner device 100 may transmit signals of a single format through the single communication line after encrypting the signals. Furthermore, the tuner module may receive an encrypted signal transmitted by the head unit 200, may decrypt the received signal, may process the decrypted signal, and may extract information through such signal processing.

For reference, the integrated tuner device 100 may be preferably configured to include a self-control unit capable of controlling an operation for processing a plurality of multimedia signals and controlling the initialization operation of the integrated tuner device 100.

The head unit 200 is a device for providing a direct multimedia service to a user within a transportation apparatus and means an element for implementing a plurality of multimedia services through a signal received from the integrated tuner device 100.

The head unit 200 includes an interface device, such as an input unit capable of receiving information from a user and may receive manipulation information (service selection, operation control, etc.) required to provide a multimedia service from a user through such an interface device. Furthermore, the head unit 200 may provide a plurality of multimedia services (e.g., the reception of an analog broadcasting service, the reception of a digital broadcasting service, a telematics service, a communication service, and other services) through manipulation information received through the interface and a signal transmitted by the integrated tuner device. In order to provide such services, the head unit 200 may include output devices, such as a voice output unit and a display unit.

Meanwhile, the head unit 200 may be configured in such a way as to transmit and receive signals to and from the integrated tuner device 100 through a single communication line. Furthermore, the head unit 200 may also be configured in such a way as to receive signals of a single format through the single communication line and to transmit signals of a single data format through the single communication line. Furthermore, the head unit 200 may process a process for transmitting signals of a single format after encrypting the signal or decrypting an encrypted signal after receiving the encrypted signal. As a result, the head unit 200 may transmit and receive signals of a single format that have been encrypted through the single communication line. Through such a configuration, a line loss, a mismatch between signals, performance regarding reception sensitivity can be improved, and integral management can be performed. Furthermore, complexity in the wiring task of a transportation apparatus can be significantly reduced, productivity can be improved, and fuel efficiency of a transportation apparatus can be improved due to a reduction of the number of lines.

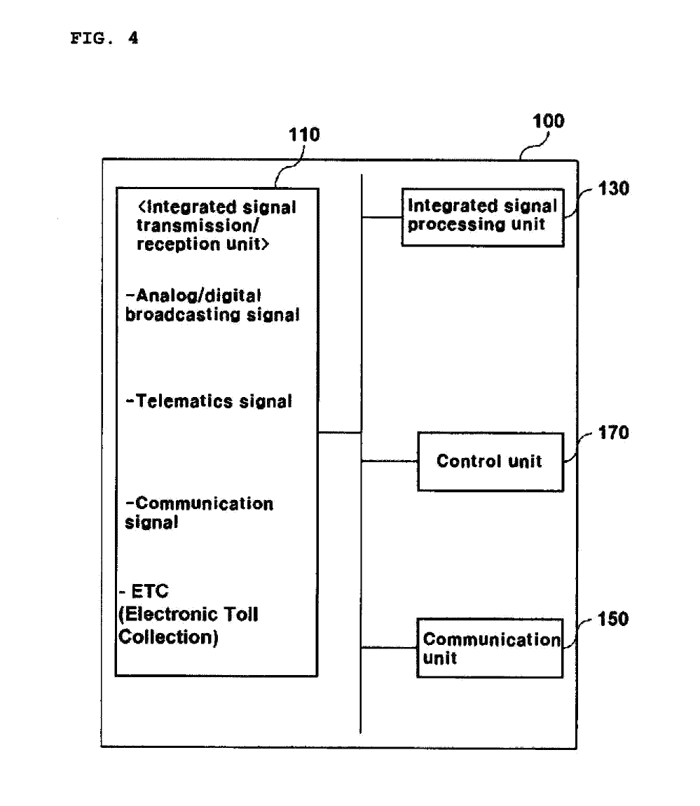

The configuration of the multimedia system for a transportation apparatus in accordance with an embodiment of the present invention is described in more detail below with reference to FIGS. 4 to 7.

Referring to FIG. 4, the integrated tuner device 100 which may be included in the multimedia system for a transportation apparatus in accordance with an embodiment of the present invention may include an integrated signal transmission/reception unit 110 which is connected to the antenna and which transmits and receives a plurality of multimedia signals, an integrated signal processing unit 130 which processes a signal received by the integrated signal transmission/reception unit and extracts multimedia information, a communication unit 150 for transmitting and receiving signals to and from the head unit, and a control unit 170 for controlling the operations of the integrated signal transmission/reception unit, the integrated signal processing unit, and the communication unit.

Furthermore, the integrated tuner device 100 may further include a storage unit capable of storing data necessary for the operations of the integrated tuner device 100 including the integrated signal transmission/reception unit 110, the integrated signal processing unit 130, the communication unit 150, and the control unit 170.

The integrated signal transmission/reception unit 110 means an element capable of transmitting and receiving signals to and from the antenna 300. More specifically, the integrated signal transmission/reception unit 110 means an element capable of receiving a plurality of multimedia signals from the antenna 300 and transmitting a plurality of signals to be externally transmitted to the antenna 300.

The integrated signal transmission/reception unit 110 may receive signals for implementing various multimedia services, such as an analog broadcasting signal, a digital broadcasting signal, a telematics service signal, communication service signal, and other service signals, from the antenna 300 and transmit signals for implementing various multimedia services to the antenna 300.

Furthermore, as described above, the integrated signal transmission/reception unit 110 is preferably installed close to the antenna 300 and is preferably connected to the plurality of radiating elements that may be included in the antenna 300 through a plurality of short lines.

The integrated signal processing unit 130 is an element that functions to process a signal received by the integrated signal transmission/reception unit 110, extract multimedia information included in a signal or process a signal to be externally transmitted, and transfer the processed to the integrated signal transmission/reception unit 110.

The integrated signal processing unit 130 may process a plurality of multimedia signals received by the integrated signal transmission/reception unit 110 and extract information data for implementing an analog broadcasting service, a digital broadcasting service, a telematics service, a communication service, and other services.

Furthermore, the integrated signal processing unit 130 may convert information data to be externally transmitted through the antenna 300 in a transmission signal form and transfer the converted data to the integrated transmission/reception unit.

The communication unit 150 is a device for transmitting and receiving signals to and from the head unit 200 and may be implemented in various forms, such as a wired communication device or a wireless communication device.

The communication unit 150 may preferably transmit and receive signals to and from the head unit 200 through single communication line. In this case, the single communication line means a single physical path for exchanging signals and may be implemented using various communication methods capable of transmitting and receiving signals. For example, the single communication line may be implemented using various forms of physical paths, such as Ethernet, a USB, Wi-Fi, a wired line, and other digital communication lines.

Meanwhile, when transmitting and receiving signals through the single communication line, the communication unit 150 may transmit and receive signals of a single format. Furthermore, the communication unit 150 may encrypt signals of a single format and then transmit the encrypted signals through the single communication line.

The control unit 170 means an element that controls the operation of the integrated tuner device 100, including the integrated signal transmission/reception unit 110, the integrated signal processing unit 130, and the communication unit 150.

The control unit 170 is a self-element of the integrated tuner device 100 independent from the head unit 200 and preferably controls the operations of the integrated signal transmission/reception unit 110, the integrated signal processing unit 130, and the communication unit 150 in association with the head unit 200.

Furthermore, the control unit 170 may convert a plurality of pieces of multimedia information that may be extracted by the integrated signal processing unit 130 into signals of a single format. More specifically, the control unit 170 may convert extracted multimedia information into signals of a single format by not taking into consideration the type of information extracted by the integrated signal processing unit 130 and may control converted signals so that they are transmitted to the head unit 200 through the single communication line.

Furthermore, the control unit 170 may extract information by processing signals received by the head unit 200 and control the functions of respective multimedia services based on the extracted information. For example, the control unit 170 may extract user manipulation information from a signal received by the head unit 200 and may control the functions of the respective multimedia services (including control the operations of the integrated transmission/reception unit, the integrated signal processing unit 130, and the communication unit 150) based on the extracted manipulation information so that a specific multimedia service that satisfies a user need is provided.

Meanwhile, the control unit 170 may be configured in such a way as to mainly control the entire multimedia system for a transportation apparatus. More specifically, the control unit 170 may be configured to become the higher control means of the head unit 200 so that it mainly controls the entire system through the control unit 170. In this case, the control unit 170 may perform an operation capable of initializing both the integrated tuner device 100 and the head unit 200 and may generally control all the operations of the head unit 200, the integrated tuner device 100, and the antenna 300.

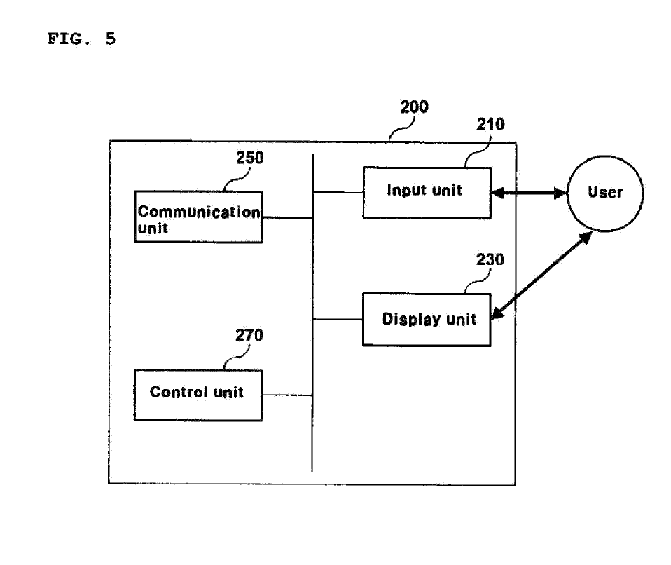

Referring to FIG. 5, the head unit 200 which may be included in the multimedia system for a transportation apparatus in accordance with an embodiment of the present invention may include an input unit 210 for receiving information from a user, a display unit 230 for displaying a multimedia service, a communication unit 250 for transmitting and receiving signals to and from the integrated tuner device, and a control unit 270 for controlling the operations of the input unit, the display unit, and the communication unit.

Furthermore, the head unit 200 may further include a power unit capable of supplying power to the integrated tuner device 100 or the head unit 200 and a storage unit capable of storing data necessary for the operation of the head unit 200 and may further include an output unit, such as a voice output unit for outputting a multimedia service.

The input unit 210 is an element for receiving manipulation information related to a multimedia service from a user. More specifically, the input unit 210 may receive information, such as multimedia service information requested to be executed and detailed manipulation information within a corresponding service, so that a user is provided with desired multimedia service through the provision of such information.

The input unit 210 may be configured in a form including buttons or may be configured in a touch screen form and may be implemented using various methods in addition to such forms.

The display unit 230 means display means for displaying the contents of a multimedia service. The display unit 230 displays the content of each multimedia service based on pieces of information transmitted by the integrated tuner device 100 and directly provides a multimedia service to a user in association with other output means, such as a voice output unit.

Meanwhile, the display unit 230 may be implemented in various forms, such as an LCD or an LED, and may also be implemented in a touch screen form in combination with the input unit 210.

The communication unit 250 is a device for transmitting and receiving signals to and from the integrated tuner device 100 and may be implemented in various forms, such as a wired communication device and a wireless communication device.

The communication unit 250 may transmit and receive signals to and from the integrated tuner device 100 through a single communication line preferably. In this case, the single communication line means a single physical path for exchanging signals and may be implemented using various communication methods capable of transmitting and receiving signals. For example, the single communication line may be implemented through various forms of physical paths, such as Ethernet, a USB, Wi-Fi, a wired line, and other digital communication line.

Meanwhile, when transmitting and receiving signals through the single communication line, the communication unit 250 may transmit and receive signals of a single format. Furthermore, the communication unit 250 may encrypt signals of a single format and then transmit and receive the encrypted signals.

The control unit 270 is an element for controlling an overall operation of the head unit 200, including the input unit 210, the display unit 230, the output unit, the power unit, the storage unit, and the communication unit 250.

The control unit 270 does not control tuner devices for a plurality of multimedia services unlike in the conventional head unit 200 and may be configured to have a reduced computation load for information processing. Furthermore, the control unit 270 may also be configured to be initialized or to control a detailed operation based on a control signal from the integrated tuner device 100 capable of performing a main control function.

Meanwhile, the control unit 270 may extract information about each multimedia service by processing signals of a single format received from the integrated tuner device 100 and may control the operation of the head unit 200 based on the extracted information.

Furthermore, if a received signal has been encrypted, the control unit 270 may perform a decryption process for decrypting the encrypted signal and then extract information. The control unit 270 may convert information to be transmitted to the integrated tuner device 100 into an encrypted signal and transmit the encrypted signal.

Furthermore, when transmitting information to the integrated tuner device 100, the control unit 270 may transmit a signal using the same format as that of a signal transmitted by the integrated tuner device 100.

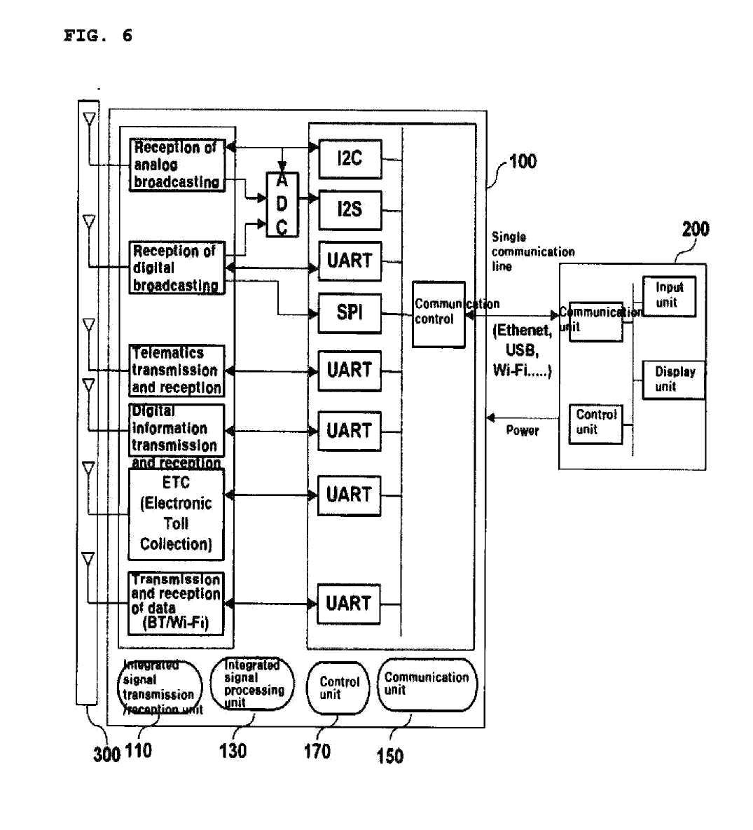

Referring to FIG. 6, the integrated tuner device 100 and the head unit 200 may transmit and receive signals through a single communication line. In this case, the single communication line means a single physical path for exchanging signals and may be implemented using various transmission methods capable of transmitting and receiving signals. For example, the single communication line may be implemented using various forms of physical paths, such as Ethernet, a USB, Wi-Fi, a wired line, and other digital communication lines.

The integrated tuner device 100 processes service signals, such as an analog broadcasting signal, a digital broadcasting signal, a telematics service signal, a communication signal, a digital information signal, and other signals, and then transmits the processed signals to the head unit 200 through the communication unit 250. In this case, a plurality of multimedia signals to be transmitted is converted into signals of a single format after signal processing and is preferably encrypted and transmitted to the head unit 200.

Furthermore, the head unit 200 transmits pieces of information related to a service, such as user manipulation information, to the integrated tuner device 100. Likewise, the head unit 200 transmits pieces of information through signals of a single format. In this case, the signals of a single format transmitted are preferably encrypted.

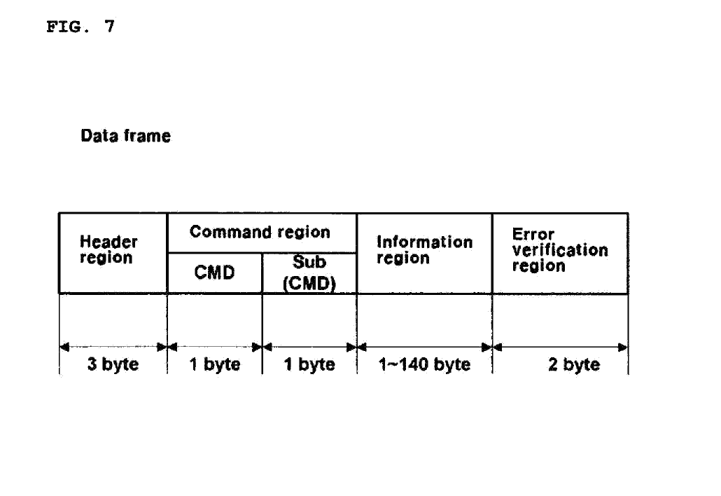

An embodiment of a signal of a single format that may be transmitted and received through the single communication line may be described with reference to FIG. 7. More specifically, the single data format of the signal may include a header region, a command region, an information region, and an error verification region.

The header region is a region in which a name unique to a system is written in order to prevent confusion between systems.

The command region is a region indicative of a command (data) regarding a specific service of the plurality of multimedia services. The command region may include a CMD region for identifying a multimedia service and a sub-CMD region for identifying a detailed function within a service.

The information region is a region including multimedia service information and may preferably include encrypted information data.

The error verification region is a region used for the error verification of a signal.

Various signals extracted from a plurality of multimedia signals can be sorted through the encrypted signal of a single format and transmitted and received through a single communication line.

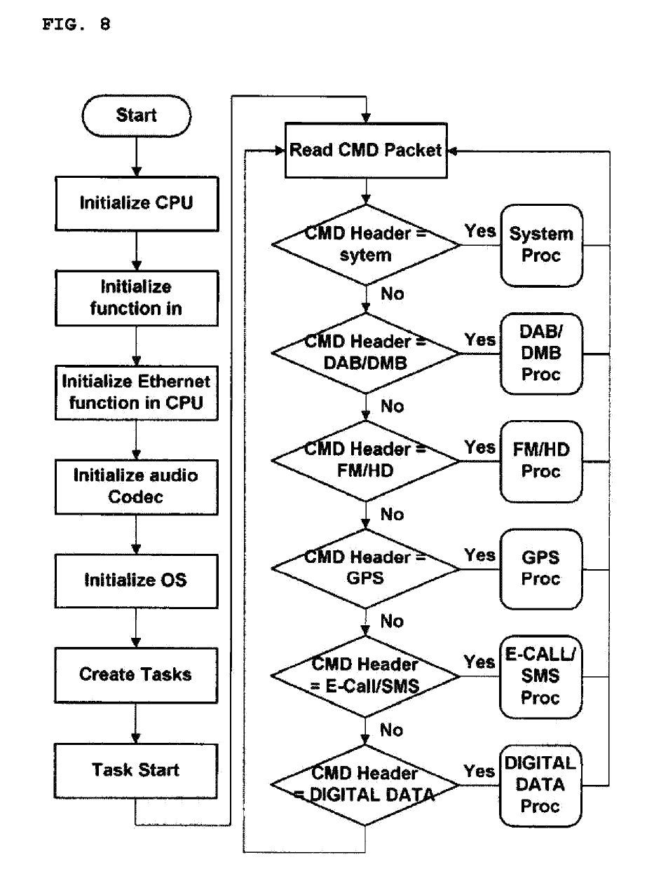

A process of the system operating is described based on the operation of the integrated tuner device 100 with reference to FIG. 8. The control unit of the integrated tuner device 100 is initialized, and functions for providing a plurality of multimedia services are initialized. Furthermore, the operations of the integrated signal transmission/reception unit 110, the integrated signal processing unit 130, and the communication unit 150 within the integrated tuner device 100 are initialized. For example, the function of the integrated signal transmission/reception unit 110 for receiving a signal from the antenna 300 is initialized. The function of a single communication line, such as Ethernet for communication with the head unit 200, is initialized. The function of the integrated signal processing unit 130 for processing a plurality of multimedia signals, such as an audio codec for converting an analog signal, is initialized.

When such an initialization process is completed, the system enters a communication standby state with the head unit 200.

A single physical path is formed between the head unit 200 and the integrated tuner device 100, but the head unit 200 and the integrated tuner device 100 may exchange pieces of information for several functions through a plurality of logical paths. More specifically, the physical path is one, but a plurality of logical paths may be configured because pieces of information (distinguished within the format of a signal) for implementing a plurality of multimedia services are transmitted and received through the path.

The integrated tuner device 100 controls the operation of each element based on information transmitted by the head unit 200. For example, a plurality of multimedia services selectively controlled based on the command region included in transmitted information.

In the aforementioned multimedia system for a transportation apparatus in accordance with an embodiment of the present invention, tuner devices for a plurality of multimedia services may be configured in the form of the integrated tuner device 100, and the integrated tuner device 100 may be configured in a form independent from the head unit. Accordingly, the integrated tuner device 100 can deviate from the influence of noise (electric field noise) generated from an engine or driving motors near the head unit 200, the integrated tuner device 100 may not be subject to interference from a variety of types of synchronization clock signals within the head unit, and reception sensitivity of the integrated tuner device 100 can be significantly improved.

Furthermore, in the multimedia system for a transportation apparatus in accordance with an embodiment of the present invention, the independent integrated tuner device 100 may be configured to be installed close to the antenna 300. Accordingly, a mismatch loss that may occur between the antenna 300 and the tuner device can be reduced, and reception sensitivity can be significantly improved.

Furthermore, in the multimedia system for a transportation apparatus in accordance with an embodiment of the present invention, the integrated tuner device 100 and the head unit 200 configured in an independent form are coupled through a single communication line, and can exchange signals according to a single data format. Accordingly, a line loss, a mismatch between signals, and reception sensitivity do not need to be separately managed with respect to each of a plurality of tuner devices (a plurality of coaxial lines), and a plurality of multimedia signals can be integrally managed. Furthermore, complexity in the wiring task of a transportation apparatus can be significantly reduced, productivity can be improved, and fuel efficiency of a transportation apparatus can be improved due to a reduction in the number of lines.

Furthermore, in the multimedia system for a transportation apparatus in accordance with an embodiment of the present invention, the integrated tuner device 100 physically independent from the head unit 200 may include the independent control unit, and thus a plurality of multimedia service functions can be autonomously controlled through the control unit. Accordingly, a load of the head unit 200 can be reduced because the amount of information processed by the head unit 200 is reduced. Furthermore, a plurality of multimedia service signals to be transmitted to the head unit 200 can be converted into an output signal of a single format through a previous control operation of the independent control unit, and the converted signals can be transmitted through a single communication line.

Furthermore, in the multimedia system for a transportation apparatus in accordance with an embodiment of the present invention, the main control unit may be placed within the integrated tuner device. Accordingly, integrated control can be performed based on the operation of the integrated tuner device 100.

The aforementioned embodiments of the present invention have been disclosed for illustrative purposes, and the present invention is not restricted by the embodiments. Furthermore, those skilled in the art to which the present invention pertains may modify and change the present invention in various ways within the spirit and scope of the present invention, and such modifications and changes should be construed as belonging to the scope of the present invention.

1. A multimedia system for a transportation apparatus, including:
an antenna for transmitting and receiving signals;
an integrated tuner device for processing the signals transmitted by the antenna; and
a head unit for implementing a multimedia service through the signals transmitted by the integrated tuner device,
wherein the integrated tuner device is configured in a form independent from the head unit, and the integrated tuner device is installed near the antenna.

2. The multimedia system of claim 1, wherein:
the integrated tuner device integrally receives and processes a plurality of multimedia signals, and
the plurality of multimedia signals comprises a broadcasting signal, a communication signal, or a telematics service signal.

3. The multimedia system of claim 2, wherein the integrated tuner device and the head unit mutually transmit and receive signals according to a single data format through a single communication line.

4. The multimedia system of claim 2, wherein the integrated tuner device comprises a self-control unit capable of controlling an operation for processing the plurality of multimedia signals and of controlling an initialization operation of the integrated tuner device.

5. The multimedia system of claim 2, wherein the integrated tuner device comprises:
an integrated signal transmission/reception unit which is connected to the antenna and transmits and receives the plurality of multimedia signals;
an integrated signal processing unit which processes the signals received by the integrated signal transmission/reception unit and extracts multimedia information;
a communication unit for transmitting and receiving signals to and from the head unit; and
a control unit for controlling operations of the integrated signal transmission/reception unit, the integrated signal processing unit, and the communication unit.

6. The multimedia system of claim 5, wherein:
the control unit converts extracted multimedia information into signals of a single format that is capable of including a header region, a command region, an information region, and an error verification region by not taking into consideration a type of the extracted multimedia information, and
the communication unit transmits and receives signals to and from the head unit through a single communication line.

7. The multimedia system of claim 6, wherein the information region comprises encrypted multimedia service information.

8. The multimedia system of claim 6, wherein the control unit is capable of controlling operations of the integrated signal transmission/reception unit, the integrated signal processing unit, and the communication unit based on a signal transmitted by the head unit.
